(19) United States
(12) Patent Application Publication
(10) Pub. No.: US 2025/0125386 A1
(43) Pub. Date: Apr. 17, 2025

(54) INJECTOR/EJECTOR FOR A FUEL CELL

(71) Applicant: GM GLOBAL TECHNOLOGY OPERATIONS LLC, Detroit, MI (US)

(72) Inventors: Glenn W. Skala, Churchville, NY (US); Devesh Pande, Lake Orion, MI (US); Timothy J. Howitt, Oxford, MI (US); Joseph Hahn, White Lake Township, MI (US)

(73) Assignee: GM GLOBAL TECHNOLOGY OPERATIONS LLC, Detroit, MI (US)

(21) Appl. No.: 18/486,224

(22) Filed: Oct. 13, 2023

(51) Int. Cl. H01M 8/04089; H01M 8/04082

(52) U.S. Cl. CPC H01M 8/04097; H01M 8/04201

(57) ABSTRACT

An injector/ejector assembly for a fuel cell. The assembly includes a body portion that extends along a central longitudinal axis. Recirculation flow passages are formed by and extend through the body portion. Each of the recirculation flow passages extend from a corresponding recirculation flow inlet to a corresponding recirculation flow outlet. A motive flow passage is formed by and extends through the body portion and reeds enclose at least a portion of the corresponding recirculation flow outlet for each of the recirculation flow passages.

The subject disclosure relates to the art of fuel cells and, more particularly, to combining recirculation flow from a fuel cell stack with a motive flow of fuel.

A fuel cell is a device that generates electricity by a chemical reaction. Every fuel cell has two electrodes, one positive and one negative, called, respectively, the cathode and the anode. The reactions that produce electricity take place at the electrodes. Every fuel cell also has an electrolyte, which carries electrically charged particles from one electrode to the other, and a catalyst, which speeds the reactions at the electrodes. Hydrogen is the basic fuel, but fuel cells also require oxygen. One advantage of fuel cells is that they generate electricity with very little pollution, i.e., much of the hydrogen and oxygen used in generating the electricity ultimately combine to form a harmless byproduct, namely water.

### SUMMARY

Disclosed here is an injector/ejector assembly for a fuel cell. The assembly includes a body portion that extends along a central longitudinal axis. Recirculation flow passages are formed by and extend through the body portion. Each of the recirculation flow passages extend from a corresponding recirculation flow inlet to a corresponding recirculation flow outlet. A motive flow passage is formed by and extends through the body portion and reeds enclose at least a portion of the corresponding recirculation flow outlet for each of the recirculation flow passages.

Another aspect of the disclosure may be where the recirculation flow passages are positioned circumferentially around the body portion.

Another aspect of the disclosure may be where each of the reeds are attached to the body portion adjacent an upstream end of each of the reeds relative to a direction of flow through the assembly.

Another aspect of the disclosure may be where the body portion includes a base portion having an outer perimeter surface that separates each of the corresponding recirculation flow inlet from the corresponding recirculation flow outlet for each of the recirculation flow passages.

Another aspect of the disclosure may include ribs that extend from a rib body portion that is fixed relative to the body portion. The ribs being located radially outward from a corresponding one of the reeds.

Another aspect of the disclosure may be where the reeds each taper from a base towards a distal end.

Another aspect of the disclosure may be where at least a portion of the motive flow passage extends along the central longitudinal axis.

Another aspect of the disclosure may be where the motive flow passage includes an outlet at a distal end of the body portion located downstream relative to the central longitudinal axis of the recirculation flow outlet.

Another aspect of the disclosure may be where a portion of an inlet to the motive flow passage is transverse to the recirculation flow passages.

Another aspect of the disclosure may be where a proximal end of each of the reeds is fixed from moving relative to the body portion.

Another aspect of the disclosure may be where the reeds include six circumferentially spaced reeds surrounding the body portion.

Disclosed herein is a fuel cell system. The system includes at least one fuel cell having an anode inlet and an anode outlet. A hydrogen tank is in fluid communication with the anode inlet. An injector/ejector is in fluid communication with the hydrogen tank, the anode inlet, and the anode outlet. The injector/ejector includes a body portion extending along a central longitudinal axis. Recirculation flow passages are formed by and extend through the body portion with each of the recirculation flow passages extending from a corresponding recirculation flow inlet to a corresponding recirculation flow outlet. A motive flow passage is formed by and extends through the body portion and reeds enclose at least a portion of the corresponding recirculation flow outlet for each of the recirculation flow passages.

Disclosed herein is a method of operating a fuel cell system. The method includes directing fuel from a fuel source into a motive flow passage in a body portion of an injector/ejector assembly with the body portion extending along a central longitudinal axis. A recirculation flow from an anode outlet on a fuel cell is directed into one of a set of recirculation flow passages that extend through the body portion. The recirculation flow and the fuel from the fuel source mix downstream of a recirculation flow outlet and a motive flow outlet. Reeds enclose at least a portion of the corresponding recirculation flow outlet for each of the recirculation flow passages.

### BRIEF DESCRIPTION OF THE DRAWINGS

Other features, advantages and details appear, by way of example only, in the following detailed description, the detailed description referring to the drawings in which:

FIG. 1 schematically illustrates a fuel cell system.

FIG. 2 illustrates a front perspective view of an injector/ejector assembly from the fuel cell system of FIG. 1.

FIG. 3 illustrates a rear perspective view of the injector/ejector assembly from FIG. 2.

FIG. 4 illustrates a front view of the injector/ejector assembly from FIG. 2.

FIG. 5 illustrates a front view of the injector/ejector assembly FIG. 2.

FIG. 6 illustrates a rear perspective view of the injector/ejector assembly from FIG. 2 without reeds.

FIG. 7 illustrates a perspective view of reeds used with injector/ejector assembly from FIG. 2.

FIG. 8 schematically illustrates a recirculation flow and a motive flow through the injector/ejector assembly from FIG. 2.

FIG. 9 illustrates an example method of operating a fuel cell system of FIG. 1 with the injector/ejectors disclosed herein.

FIG. 10 illustrates a front perspective view of another example injector/ejector assembly from fuel cell system of FIG. 1.

FIG. 11 illustrates a rear perspective view of the injector/ejector assembly of FIG. 10.

FIG. 12 illustrates a perspective view of reeds used with injector/ejector assembly from the fuel cell system of FIG. 10.

FIG. 13 illustrates a rear perspective view of the injector/ejector assembly from the fuel cell system of FIG. 10 without reeds.

FIG. 14 illustrates a rear perspective view of a rib body portion having a plurality of ribs.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Referring now to the drawings, wherein like numerals indicate like parts in the several views, a fuel cell system 20 and a method 100 for operating or controlling the fuel cell system 20 are shown and described herein.

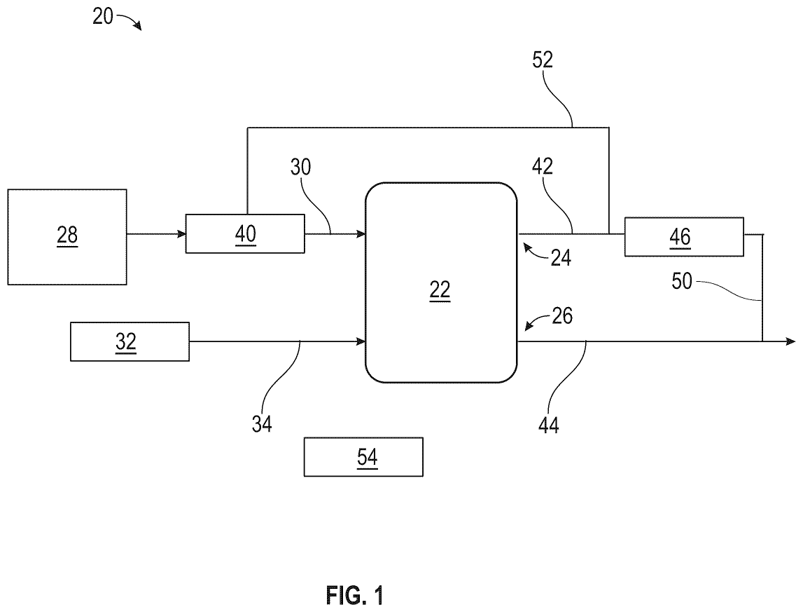

FIG. 1 illustrates an example fuel cell system 20. The fuel cell system 20 includes a fuel cell stack 22 having an anode 24 and a cathode 26. Hydrogen gas is fed from a fuel source 28, such as a hydrogen fuel cell source, to the anode 24 via an anode input line 30, and oxygen or air is fed from a compressor 32 or other oxygen/air source to the cathode 26 via a cathode input line 34. An injector/ejector 40 includes an injector or injector portion and an ejector or ejector portion is located downstream of the fuel source 28 and in fluid communication with the anode input line 30.

An anode exhaust line 42 extends from an exit of the anode 24, and a cathode exhaust line 44 extends from an exit of the cathode 26. The anode exhaust line 42 may carry unused hydrogen gas away from the anode 24, and the cathode exhaust line 44 may carry unused oxygen/air away from the cathode 26. In either or both of the exhaust lines 42, 44, water and other liquids or gases may be carried away from the fuel cell stack 22. An anode exhaust valve 46 may be disposed in the anode exhaust line 42, with the portion of the anode exhaust line 42 that is downstream of the anode exhaust valve 46 being joined with the cathode exhaust line 44 and having an anode exhaust valve flow rate 50.

A recirculation line 52 runs from a first end, which is connected with a portion of the anode exhaust line 42 upstream of the anode exhaust valve 46, to a second end, which is connected with the ejector portion of the injector/ejector 40. In this arrangement, at least a portion of the unused hydrogen gas which passes into the anode exhaust line 42 from the anode 24 may be directed back into the anode 24 via the recirculation line 52.

The fuel cell system 20 also includes a controller 54 in electrical communication with various portions of the fuel cell system 20, such as the injector/ejector 40, anode exhaust valve 46, and compressor 32, for performing the method 100 disclosed herein.

The electronic controller 54 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

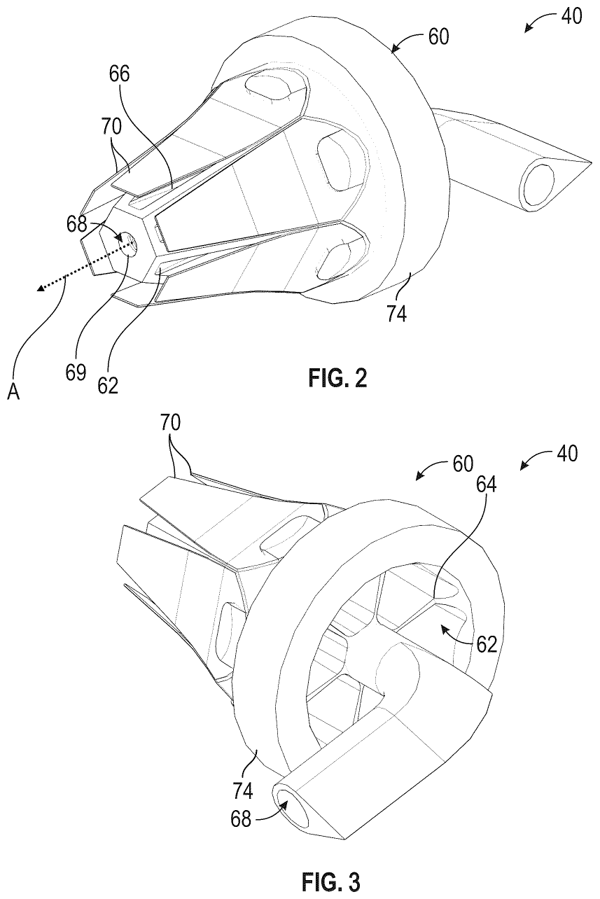

As shown in FIGS. 2-5, the injector/ejector assembly 40 includes a body portion 60 that extends along a central longitudinal axis A. A plurality of recirculation flow passages 62 extend through the body portion 60 from a recirculation flow inlet 64 adjacent a proximal end of the body portion 60 to a recirculation flow outlet 66 adjacent a distal end of the body portion 60. Both the recirculation flow inlet and outlets 64, 66 are defined on a perimeter by the body portion with a cross-sectional area of the recirculation flow outlets 66 being larger than a cross sectional area of the recirculation flow inlets 64.

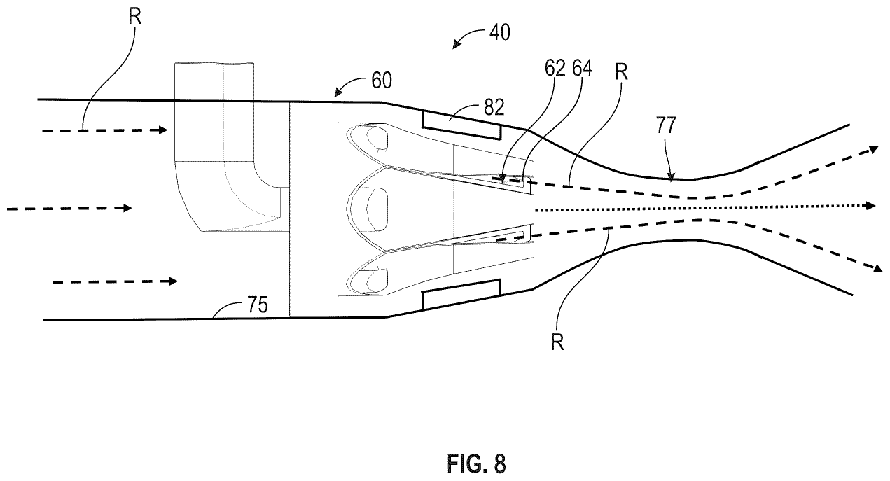

The proximal end of the body portion 60 includes an outer perimeter surface 74 that separates an upstream end of the body portion 60 from a downstream portion of the body portion by engaging a passage wall 75 upstream of an ejector throat 77 (FIG. 8). In the illustrated example, the outer perimeter surface 74 defines a circular sealing surface.

A motive flow passage 68 extending through the body portion 60 along the central longitudinal axis A. In the illustrated example, a portion of the motive flow passage 68 extends transverse to the central longitudinal axis A and across at least one of the plurality of recirculation flow passages 62. Also, the portion of the motive flow passage 68 that is transverse to the central longitudinal axis includes an upstream edge having a radius of curvature that tapers to a leading edge along an upstream most portion relative to a direction of flow through the body portion 60. The plurality of recirculation flow passages 62 are positioned circumferentially around the body portion 60 and encircle the motive flow passage 68. An outlet 69 of the motive flow passage 68 is located distal of the recirculation flow outlets 66.

A plurality of reeds 70 at least partially enclose corresponding recirculation flow outlets 66 in the body portion 60 to prevent back flow through the recirculation flow passages 62. In the illustrated example, the plurality of reeds 70 includes six reeds 70 that are each attached to the body portion 60 adjacent a proximal or upstream end of the reed 70 relative to a direction of flow through the body portion 60. The reeds 70 are located axially upstream of the outlet 69 of the motive flow passage 68 relative to the longitudinal axis A (FIG. 2).

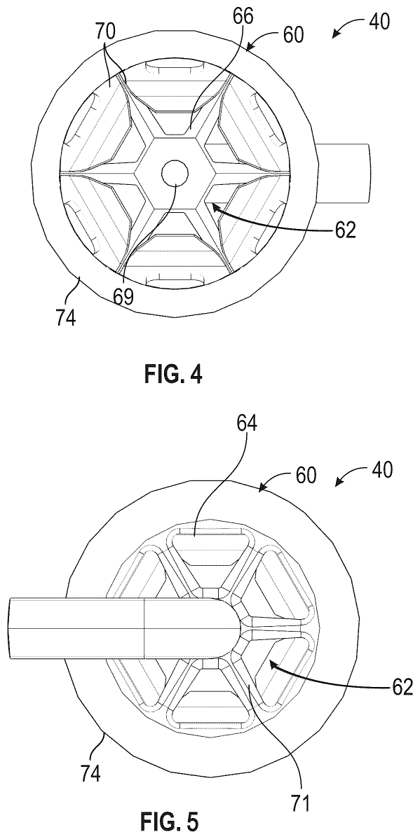

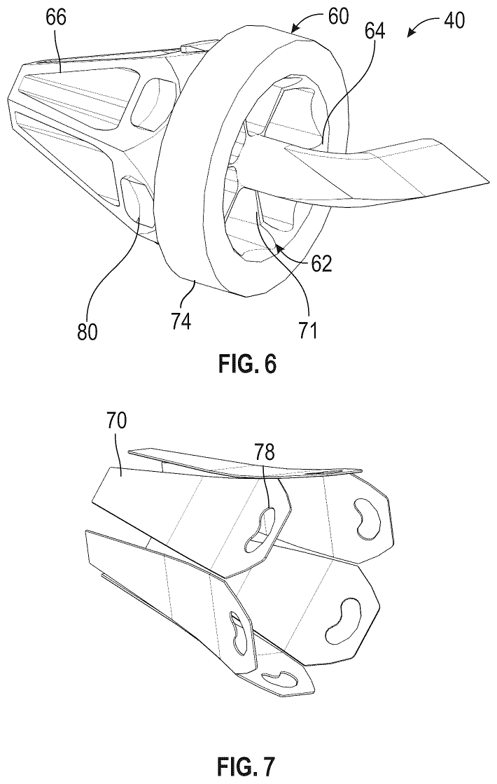

As shown in FIGS. 6-7, the reeds 70 include a base or proximal end with an attachment opening 78 for engaging fastener 80. The fastener 80 can be integral with the body portion 60, such as formed during an over mold process with the plurality of reeds, or by a heat staking process. As shown in FIG. 4, the recirculation flow outlets 66 are elongated and taper in width towards a distal end of the body portion 60. Similarly, the reeds 70 and taper in width towards a distal end. One feature of the reeds 70 and the recirculation flow passages 62 is to turn the flow of recirculation gases with walls 71 between adjacent recirculation flow passages 62 in a direction parallel to the direction of flow of the motive gases through the motive flow passage 68. This reduces the amount of turning the recirculation flow F encounters before being mixed with the motive flow M from the fuel source 28.

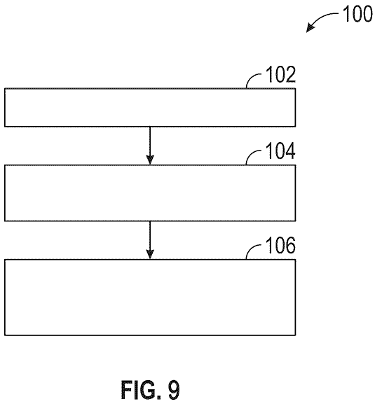

FIG. 9 illustrates a method 100 of operating the fuel cell system 20 with the injector/ejector 40 or the injector/ejector 140 disclosed below. At Block 102, a motive flow M from the fuel source 28 is directed into the motive flow passage 68 and through the body portion 60 of an injector/ejector assembly 40 (FIG. 8). In the illustrated example, the motive flow M travels through the motive flow passage 68 transverse to a direction of flow of a recirculation flow R before turning and traveling along the central longitudinal axis A of the body portion 60. The motive flow M exits the motive flow passage 68 through the outlet 69 at the distal end of the body portion 60 downstream of the recirculation flow outlets 66 before entering the passage 75.

At Block 104, the recirculation flow R is directed from the anode outlet 24 on the fuel cell stack 22 into one of the recirculation flow passages 62 in the body portion 60. The recirculation flow R travels through the passage 75 before entering the inlets 64 to the recirculation flow passages 62 in the body portion 60. The recirculation flow R leaves the body portion 60 through the outlets 66 adjacent the reeds 70. Ribs 82 are located in the passage 75 to restrict opening of the reeds 70 and reduce a contact area between the ribs 82 and the wall of the passage 75 that could reduce the reeds 70 reaction time to changes in flow through at least one of the recirculation flow passages 62 or the motive flow passage 68.

At Block 106, the recirculation flow R and the motive flow M mix downstream of their respective outlets 66, 69 with the plurality of reeds at least partially enclosing a corresponding one of the recirculation flow outlets 66. As the recirculation flow R and the motive flow M begin to mix downstream of the body portion 60, they pass through the ejector throat 77 in the passage 75. The ejector throat 77 includes a longitudinal section of the passage 75 having a reduced cross-sectional area when compared to a portion of the passage 75 including the injector/ejector 40 and a portion of the passage 75 downstream of the ejector throat 77.

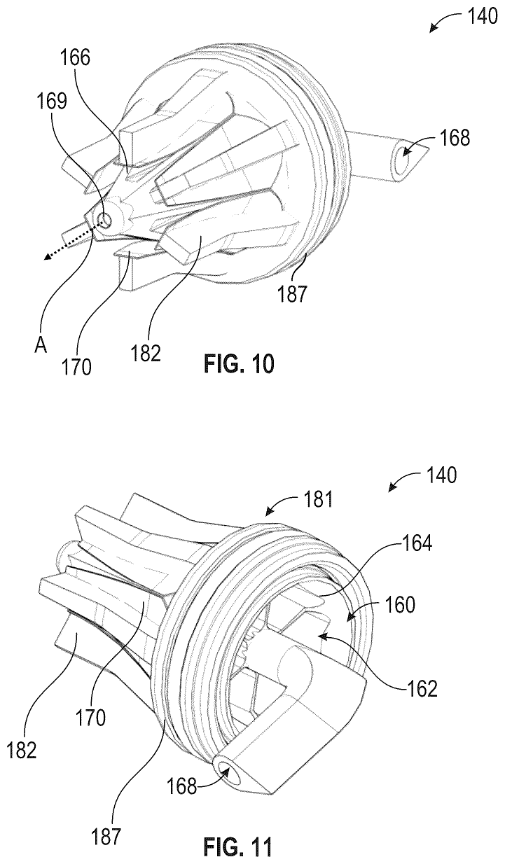

FIGS. 10-14 illustrate another example injector/ejector assembly 140. The injector/ejector assembly 140 is similar to the injector/ejector assembly 40 except where described below or shown in the drawings. Similar elements will include the addition of a leading “1”.

As shown in FIGS. 10-14, the injector/ejector assembly 140 includes a body portion 160 that extends along a central longitudinal axis A. A plurality of recirculation flow passages 162 extend through the body portion 160 from a recirculation flow inlet 164 adjacent to a proximal end of the body portion 160 to a recirculation flow outlet 166 adjacent to a distal end of the body portion 160. Both the recirculation flow inlet and outlets 164, 166 are defined on a perimeter by the body portion 160 with a cross-sectional area of the recirculation flow outlets 166 being larger than a cross sectional area of the recirculation flow inlets 164.

The proximal end of the body portion 160 includes an outer perimeter surface 174 that separates an upstream end of the body portion 160 from a downstream portion of the body portion 160. In one example, the outer perimeter surface 174 includes a channel 175 for accepting a seal, such as an o-ring seal, to create a seal with a body portion contact surface 185 on a rib body portion 181 that supports ribs 182. In the illustrated example, the outer perimeter surface 74 defines a circular sealing surface with a channel for accepting an O-ring.

A motive flow passage 168 extending through the body portion 160 along the central longitudinal axis A. In the illustrated example, a portion of the motive flow passage 168 extends transverse to the central longitudinal axis A and across at least one of the plurality of recirculation flow passages 162. Also, the portion of the motive flow passage 168 that is transverse to the central longitudinal axis includes an upstream edge having a radius of curvature that tapers to a leading edge along an upstream most portion relative to a direction of flow through the body portion 160. The plurality of recirculation flow passages 162 are positioned circumferentially around the body portion 160 and encircle the motive flow passage 168. An outlet 169 of the motive flow passage 168 protrudes past the recirculation flow outlets 166.

A plurality of reeds 170 at least partially enclose corresponding recirculation flow outlets 166 in the body portion 160 to prevent back flow through the recirculation flow passages 162. In the illustrated example, the plurality of reeds 170 includes six reeds 170 that are each attached to the body portion 160 adjacent a proximal or upstream end of the reed 170 relative to a direction of flow through the body portion 160. The reeds 170 are located axially upstream of the outlet 169 of the motive flow passage 168 relative to the longitudinal axis A (FIG. 10). Also, in the illustrated example, the plurality of reeds 170 are shown in a fully open position.

The reeds 170 are limited in travel by the ribs 182 that are formed integrally with a rib body portion 181 that forms a ring that surrounds and is fixed relative to the body portion 160. The rib body portion 181 includes a body portion contact surface 185 that is configured to form a seal with the outer perimeter surface 174 of the body portion 160. The rib body portion 181 also includes an outer perimeter surface 187 with a channel 183 for accepting a seal, such as an o-ring seal, for engaging the passage wall 75 upstream of the ejector throat 77 similar to the injector/ejector 40 shown in FIG. 8.

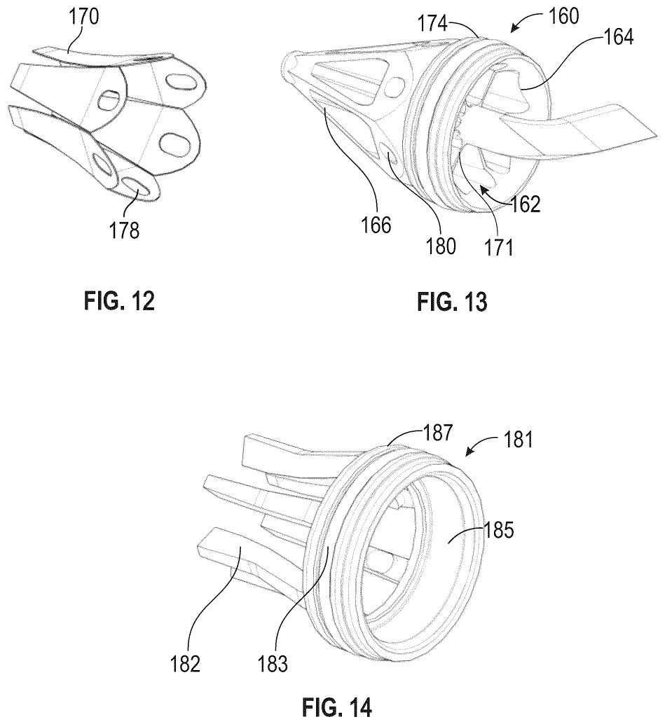

As shown in FIGS. 12-14, the reeds 170 include a base or proximal end with an attachment opening 178 for engaging fasteners 180 on the body portion 160. As shown in FIG. 13, the recirculation flow outlets 166 are elongated and taper in width towards a distal end of the body portion 160. Similarly, the reeds 170 taper in width towards a distal end. One feature of the reeds 170 and the recirculation flow passages 162 is to turn the flow of recirculation gases with walls 171 between adjacent recirculation flow passages 162 in a direction parallel to the direction of flow of the motive gases through the motive flow passage 168. This reduces the amount of turning the recirculation flow F encounters before being mixed with the motive flow M from the fuel source 28.

In an exemplary embodiment, the fuel cell system 20 is incorporated or otherwise used in a vehicle, for example, a motor vehicle. As used herein a “vehicle” is understood to mean a device configured for transporting people, things, objects, or the like. Non-limiting examples of motor vehicles (e.g., electric motor vehicles including electric battery and fuel cell vehicle or the like) include land vehicles (e.g., cars, trucks, motorcycles, electric bike, buses, trains or the like), aerial vehicles (e.g., airplanes, helicopters, unmanned aerial vehicles or the like), water vehicles (e.g., boats, watercrafts, or the like) and amphibious vehicles (e.g., hovercrafts or the like). Furthermore, the fuel cell system 20 can be utilized as part of a stationary power generation system.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, the test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. An injector/ejector assembly for a fuel cell, the assembly comprising:
a body portion extending along a central longitudinal axis;
a plurality of recirculation flow passages formed by and extend through the body portion, wherein each of the plurality of recirculation flow passages extend from a corresponding recirculation flow inlet to a corresponding recirculation flow outlet;
a motive flow passage formed by and extending through the body portion; and
a plurality of reeds enclosing at least a portion of the corresponding recirculation flow outlet for each of the plurality of recirculation flow passages.

2. The assembly of claim 1, wherein the plurality of recirculation flow passages is positioned circumferentially around the body portion.

3. The assembly of claim 1, wherein each of the plurality of reeds are attached to the body portion adjacent an upstream end of each of the plurality of reeds relative to a direction of flow through the assembly.

4. The assembly of claim 1, wherein the body portion includes a base portion having an outer perimeter surface that separates each of the corresponding recirculation flow inlet from the corresponding recirculation flow outlet for each of the plurality of recirculation flow passages.

5. The assembly of claim 4, including a plurality of ribs extending from a rib body portion that is fixed relative to the body portion with the plurality of ribs being located radially outward from a corresponding one of the plurality of reeds.

6. The assembly of claim 1, wherein the plurality of reeds each taper from a base towards a distal end.

7. The assembly of claim 1, wherein at least a portion of the motive flow passage extends along the central longitudinal axis.

8. The assembly of claim 1, wherein the motive flow passage includes an outlet at a distal end of the body portion located downstream relative to the central longitudinal axis of the recirculation flow outlet.

9. The assembly of claim 7, wherein a portion of an inlet to the motive flow passage is transverse to the plurality of recirculation flow passages.

10. The assembly of claim 1, wherein a proximal end of each of the plurality of reeds is fixed from moving relative to the body portion.

11. The assembly of claim 1, wherein the plurality of reeds includes six circumferentially spaced reeds surrounding the body portion.

12. A fuel cell system comprising:
at least one fuel cell including an anode inlet and an anode outlet;
a hydrogen tank in fluid communication with the anode inlet; and
an injector/ejector in fluid communication with the hydrogen tank, the anode inlet, and the anode outlet, wherein the injector/ejector includes:
a body portion extending along a central longitudinal axis;
a plurality of recirculation flow passages formed by and extending through the body portion, wherein each of the plurality of recirculation flow passages extend from a corresponding recirculation flow inlet to a corresponding recirculation flow outlet;
a motive flow passage formed by and extending through the body portion; and
a plurality of reeds enclosing at least a portion of the corresponding recirculation flow outlet for each of the plurality of recirculation flow passages.

13. The system of claim 12, wherein the plurality of recirculation flow passages is positioned circumferentially around the body portion.

14. The system of claim 12, wherein the body portion includes a base portion having an outer perimeter surface that separates each of the corresponding recirculation flow inlet from the corresponding recirculation flow outlet for each of the plurality of recirculation flow passages.

15. The system of claim 14, wherein the outer perimeter surface defines a circular sealing surface having a channel.

16. The system of claim 12, wherein the plurality of reeds each taper from a base towards a distal end.

17. The system of claim 12, wherein at least of portion of the motive flow passage extends along the central longitudinal axis and includes an outlet at a distal end of the body portion.

18. The system of claim 17, wherein a portion of an inlet to the motive flow passage is transverse to the plurality of recirculation flow passages.

19. A method of operating a fuel cell system, the method comprising:
directing fuel from a fuel source into a motive flow passage in a body portion of an injector/ejector assembly, wherein the body portion extends along a central longitudinal axis;
directing a recirculation flow from an anode outlet on a fuel cell into one of a plurality of recirculation flow passages extending through the body portion; and
mixing the recirculation flow and the fuel from the fuel source downstream of a recirculation flow outlet and a motive flow outlet, wherein a plurality of reeds encloses at least a portion of the corresponding recirculation flow outlet for each of the plurality of recirculation flow passages.

20. The method of claim 19, wherein the plurality of recirculation flow passages is positioned circumferentially around the motive flow passage in the body portion and the body portion includes a base portion having an outer perimeter surface that separates each of the corresponding recirculation flow inlet from the corresponding recirculation flow outlet for each of the plurality of recirculation flow passages.
